(19) United States
(12) Patent Application Publication
(10) Pub. No.: US 2002/0042889 A1
(43) Pub. Date: Apr. 11, 2002

(54) Computer system

(75) Inventors: Akira Takahashi, Niigata (JP); Hirohito Miyoshi, Yamagata (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/970,514

(22) Filed: Oct. 4, 2001

(30) Foreign Application Priority Data
Oct. 6, 2000 (JP) 307797/2000

(51) Int. Cl. G06F 1/26; G06F 1/32

(52) U.S. Cl. 713/320

(57) ABSTRACT

When a predetermined key is depressed in a power OFF state, status memory stores a status signal and a mask circuit outputs an ON signal. By the ON signal, a power circuit turns on the system power source. A processor starts to operate, accesses the status signal, and starts up a predetermined application program. When the predetermined key is depressed in a power ON state, the mask circuit masks the ON signal. A controller detects the operation of the predetermined key and outputs a signal for instructing the predetermined application program to be started up to the processor. When a power switch is depressed, the power circuit turns on the system power source. The processor starts to operate and accesses the status signal. Since no status signal is stored, the processor does not start up the predetermined application program.

### BACKGROUND OF THE INVENTION

1. Field of the Invention

The present invention relates to a computer system that is capable of performing power supply and startup of an application program easily.

2. Description of the Related Art

There is a computer system equipped with a function of starting up a predetermined application when a specific key (shortcut key) is depressed.

In the conventional computer, a shortcut button is valid for only a time period over which a system power source of computer is turned on. For this reason, the startup operation of the application due to the depression of the shortcut button can be performed only when the system power source of computer is turned on.

### SUMMARY OF THE INVENTION

According to the present invention, it is an object of the present invention to provide a system that is capable of implementing a startup operation of the corresponding application due to the depression of a shortcut button even when a system power source is an ON state.

It is another object of the present invention is to provide a computer system that is capable of performing power supply and a startup of an application program easily.

In order to attain the above object, according to a first aspect of the present invention, there is provided a computer system a computer system comprising a predetermined key for instructing a system power source to be turned on and an application program to be executed; a power key for instructing the system power source to be turned on: status memory for detecting the depression of the predetermined key to store a status signal indicative of the detection result; a mask circuit for outputting an ON signal in a state that the system power source is turned off and no ON signal in a state that the system power source is turned on in response to the depression of the predetermined key, a power control circuit for turning on the system power source in response to an operation of the power key and the ON signal; a processor, which operates by using the system power source, and accessing the status signal stored in the status memory in response to the start of the supply of power from the system power source so as to start up a predetermined application program when the status signal indicates the predetermined key has been operated; and a controller, which operates by using the system power source, for detecting the depression of the predetermined key to output a signal for instructing the processor to start up the predetermined application program.

For example, the predetermined switch outputs a signal with a predetermined level by the operation, and the status memory stores the status signal indicating the level of the signal output by the predetermined switch at the time when power supply from the system power source is started.

The controller comprises, for example, a switch circuit, which operates by the system power source, for detecting the depression of the predetermined key to output a predetermined key operation signal: and a key board controller for detecting the key operation signal to output an interrupt signal for instructing the processor to start up the predetermined application program.

The processor clears the content stored in the status memory after, for example, staring up the predetermined application program.

In order to attain the above object, according to the second aspect of the present invention, there is provided a computer system comprising a predetermined key for instructing a system power source to be turned on and an application program to be executed; a power control circuit for turning on the system power source when the predetermined key is depressed in a state that the system power source is in an OFF state; and a processor, which operates by using system power source, for executing an application program corresponding to the predetermined key when the predetermined key is depressed.

The computer system may further comprise status memory for storing the depression the predetermined key. In this case, for example, the processor accesses to the content stored in the status memory, determines whether or not system power source is turned on by the depression of the predetermined key, and executes the application program corresponding to the predetermined key when it is determined that the system power source is turned on by the depression of the predetermined key.

Moreover, the processor starts up the application corresponding to the predetermined key and clears the content stored in the status memory, for example, when system power source is turned on by the depression of the predetermined key.

The processor starts up the predetermined application, for example, when the predetermined key is depressed for a time period over which system power source is turned on.

The computer system may further comprise a power circuit and the power control circuit may detect the depression state of the predetermined key to turn on said system power source by supplying a trigger signal to the power circuit when detecting the depression of the corresponding specific key.

### BRIEF DESCRIPTION OF THE DRAWINGS

These objects and other objects and advantages of the present invention will become more apparent upon reading of the following detailed description and the accompanying drawings in which:

FIG. 1 is a block diagram illustrating a computer system according to one embodiment of the present invention;

FIG. 2 is a flowchart to explain an operation of a CPU illustrated in FIG. 1;

FIG. 3 is a circuit diagram of a status circuit illustrated in FIG. 1; and

FIGS. 4A to 4G are timing charts each explaining the operation of the status circuit of FIG. 3.

### DETAILED DESCRIPTION OF THE PREFERRED EMBODIMENT

The following will explain a computer system according to one embodiment of the present invention with reference to the drawings accompanying herewith.

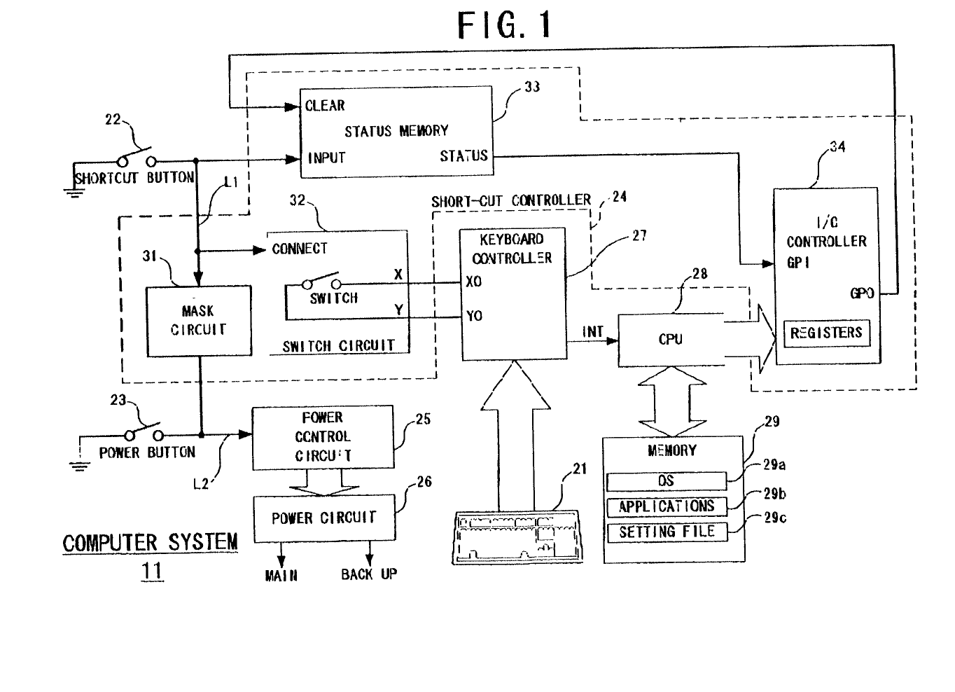

As illustrated in FIG. 1, a computer system 11 of the present embodiment comprises a keyboard 21, shortcut button 22, shortcut controller 24, power control circuit 25, power circuit 26, keyboard controller 27, CPU 28, and memory 29.

The keyboard 21 is a general keyboard.

A shortcut button 22 and power button 23 are key switches that are arranged separately from the keyboard 21. The shortcut button 22 outputs a depression signal with a ground level (“0” level) to a line L1 by the depression thereof. The power button 23 outputs a depression signal with a ground level (“0” level) to a line L2 by the depression thereof.

The shortcut controller 24 is composed of a mask circuit 31, switch circuit 32, status memory 33, and I/O controller 34. Then, the shortcut controller 24 turns on the main power of computer system 11 and launches a predetermined application program in response to the depression of shortcut button 22.

The mask circuit 31 transmits a signal (trigger signal) with a ground level on the line L, which is output when the shortcut button 22 is depressed, to the power control circuit 25 via the line L2 for a time period over which the main power is turned off. In this case, for a time period over which the main power is turned on, the mask circuit 31 interrupts the circuit and outputs no trigger signal to the line L2 even if the power button 23 is depressed so that the line L1 reaches the ground level.

When the shortcut button 22 is depressed and the signal with a ground level is supplied to a CONNECT terminal, the switch circuit 32 supplies an Y0-Y0 depression signal (matrix signal) to the keyboard controller 27. This signal is a signal indicating that the key placed at a position where an X-coordinate on the keyboard is 0 and a Y-coordinate is 0 is depressed.

More specifically, the switch circuit 32 has an X terminal and Y terminal electrically connected to an X0 terminal and Y0 terminal of the keyboard controller 27, and a switch for electrically connecting the X terminal and Y terminal to each other. When the signal with a ground level is supplied to the CONNECT terminal, the switch circuit 32 closes the switch to electrically connect the X terminal and Y terminal to each other.

On the other hand, when the shortcut button 22 is not depressed, a signal with a high level is supplied to the CONNECT terminal and the switch circuit 32 opens the switch to maintain a state in which the X terminal and Y terminal are electrically disconnected to each other.

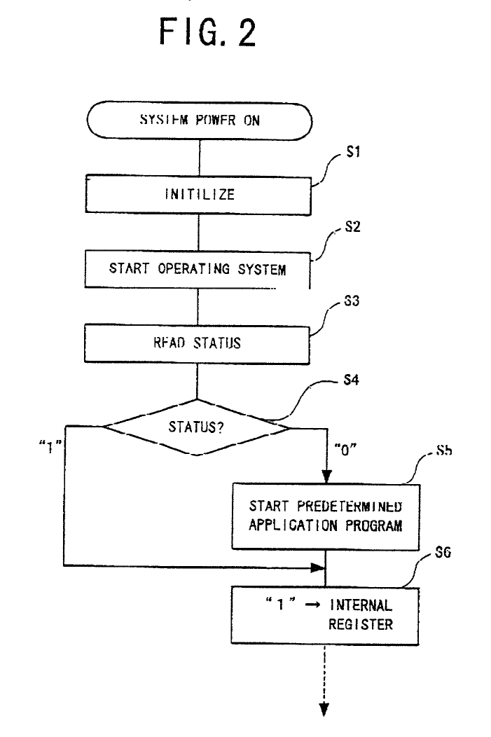

The status memory 33 has three terminals including an INPUT terminal connected to the shortcut button 22, STATUS terminal connected to an input terminal GPI of I/O controller 34, and CLEAR terminal connected to an output terminal GPO of I/O controller 34. When a system power source is turned on, the status memory 33 samples the level of signal supplied to the INPUT terminal and stores it. Then, the status memory 33 supplies the stored level to the INPUT terminal GPI of general-purpose I/O controller 34 from the STATUS terminal. Additionally, the specific circuit structure of status memory 33 will be described later with reference to FIG. 2.

The I/O controller 34 fetches a logical value of the signal supplied to the input terminal GPI to an internal register, and outputs it from the output GPO. The CPU 28 is accessible to the internal register.

The power control circuit 25 turns on/off a power circuit 26 in response to the trigger signal.

The power circuit 26 receives power supply from a power adaptor, battery, and the like and turns on/off the main power of computer system 11 under control of the power control circuit 25. Moreover, the power circuit 26 supplies backup power BK to the mask circuit 31, the power control circuit 25, and the like for even a time period over which the main power is in an OFF state, and these circuits can be operated for even a time period over which the main power is in an OFF state.

The keyboard controller 27 is composed of a general keyboard controller. The keyboard controller 27 determines as to which key on the keyboard is depressed and notifies the CPU of the result. In this embodiment, the keyboard controller 27 recognizes the shortcut button 22 as a key placed at the position of X0, Y0 of keyboard.

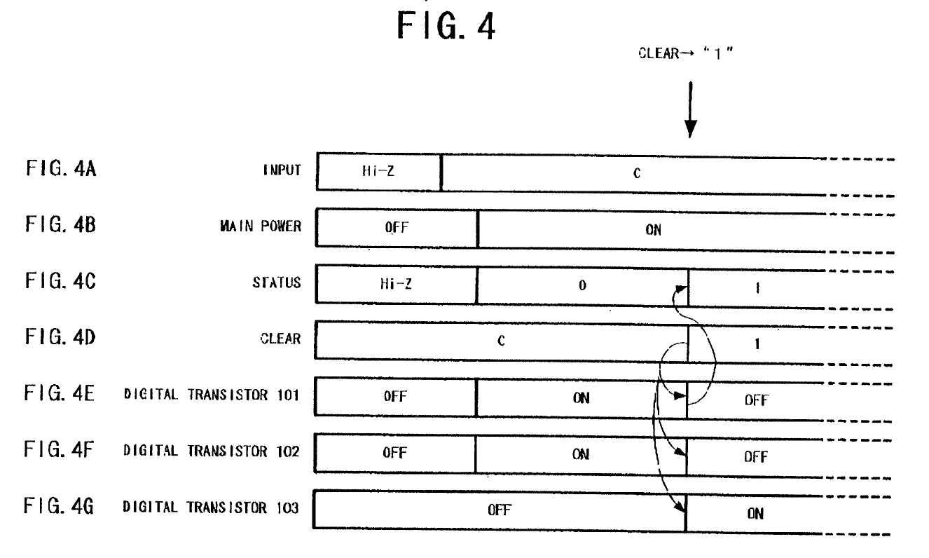

When the main power is supplied, the CPU 28 is once reset by, for example, a power reset and the like, and then executes initialization processing (step S1), startup of operating system (OS) (step S2), and reading of a value (input value of GPI terminal) of internal register provided in the I/O controller 34, sequentially as illustrated in FIG. 4. The CPU 28 determines the value of internal register (step S4). When reading that the value of internal register is “0”, the CPU 28 starts up an application program corresponding to a shortcut button 1 as a response to the fact that the shortcut button 22 is depressed (step S5). Then, the CPU 28 performs such an operation that the value of internal register is set to “1” (step S6). After that, the CPU 28 goes back to the general processing.

On the other hand, when reading that the value of internal register is “1”, the CPU 28 does not start up the application and performs such an operation that the value of internal register of I/O controller 34 is set to “1” (step S6).

Memory 29 is composed of semiconductor storage, hard disk device, and the like, and stores an OS (Operating System) 29a, application program 29b, setting file 29c, and so on. Here, the setting file 29c stores information for setting an application program to be allocated to the shortcut button 22.

The following will explain the operation of the above-configured computer system.

1) An explanation will be first given of the operation, which is performed when system power source is changed from an OFF state to an ON state by the depression of shortcut button 22.

When the shortcut button 22 is depressed in a state that system power source is in an OFF state, the signal level of transmission line L1 is changed to an L (“0”) level from a high impedance state. The switch circuit 32 does not respond to this level change since power is turned off. While, the mask circuit 31 outputs a trigger signal with an L level onto the line L2 in response to this signal change. This trigger signal is supplied to the input terminal of power control circuit 25.

The power control circuit 25 turns on the power circuit 26 in response to this trigger signal. This supplies power to the respective components of computer such as CPU 28, switch circuit 32, status memory 33, and I/O controller 34.

When the supply of power from the power circuit 26 is started, the status memory 33 stores the signal with an L level supplied to the INPUT terminal by depressing the shortcut button 22 and outputs “0” to the STATUS terminal. At this point, “0” is inputted to the CLEAR terminal.

When the supply of power from the power circuit 26 is started, the CPU 28 executes initialization processing (stop S1) and starts up the operating system (step S2) in accordance with the procedure illustrated in FIG. 4. Then, when the operating system is started, the CPU 28 gains access to the internal register of I/O controller 34 and reads the input value of input terminal GPI (step S3), and determines the value (step S4). The input value of input terminal GPI is “0” at this time, and the CPU 28 launches an application program predetermined in the setting file on the memory 29 (step S5).

Sequentially, the CPU 28 performs such an operation that the output value of the GPO terminal of an I/O controller 9 is set to “1” (step S6). As a result, “1” is inputted to the CLEAR terminal of status memory 33 and the output value of STATUS terminal is cleared to “1.”

After that, the CPU28 goes back to the general processing.

In this way, when the shortcut button 22 is depressed in a state that system power source is in an OFF state, the system power source is turned on and the application program predetermined in the setting file is started.

2) Next, it is assumed that the shortcut button 22 is depressed for a time period over which the system power source is in an ON state.

In this case, the switch circuit 32 establishes electrical connection between the X terminal and Y terminal in response to the signal with “0” value supplied to the CONNECT terminal. This allows the keyboard controller 27 to determine that a key with matrix X0-Y0 is depressed and to send an interrupt signal INT to the CPU 28. In response to this interrupt signal INT, the CPU 28 starts up a predetermined application program with reference to the setting file.

While, the mask circuit 31 does not output the trigger signal to the line L2 since the main power is supplied. Accordingly, such an erroneous operation that the power control circuit 25 restarts the power circuit 26 does not occur.

3) An explanation will, be given of the operation, which is performed when the system power source is changed from an OFF state to an ON state by the depression of power button 23.

When the shortcut button 23 is depressed in a state that the system power source is in an OFF state, the signal level of transmission line L2 is changed to an L level and the power control circuit 25 launches the system power circuit 26. The system power circuit 26 starts to supply power to each component.

The status memory 33 latches the signal level applied to the INPUT terminal in accordance with the supply of power. At this time, since the shortcut button 22 is not depressed, “1” is input to the INPUT terminal. For this reason, the status memory 33 stores “1” supplied to the INPUT terminal, and supplies “1” to the GPI terminal of I/O controller 34 from the STATUS terminal. The I/O controller 34 is initialized by the supply of power, and the signal with “0” is output from the GPO terminal and “0” is input to the CLEAR terminal of status memory 33.

When the system power source is turned on, the CPU 11 executes initialization processing (step S1), startup of operating system (step S2), and reading of input value of GPI terminal after accessing the internal register of I/O controller 34 (step S3). At this time, since the input value of GPI terminal is “1” (step S4 “1”), the CPU 11 performs such an operation that the output value of the output terminal GPO of I/O controller 34 is set to “1” without starting up the application program (step S6) and goes back to the general processing.

When the output value of the output terminal GPO of I/O controller 34 is set to “1”. “1” is input to the CLEAR terminal of status memory 33. Since the output value of STATUS terminal is “1”, “1” is continuously output from the STATUS terminal.

As explained above, according to this embodiment, the main points of the computer system may be summarized as follows:

1) When the shortcut button 22 is depressed in a state that the system power source is in an OFF state, the system power source is turned on and the predetermined application program predetermined in the setting file 29c is started up.

2) When the shortcut button 22 is depressed in a state that the system power source is in an ON state, the predetermined application program set in the setting file 29a is started up.

3) When the power button 23 is depressed in a state that the system power source is in an OFF state, the system power source is turned on.

Accordingly, the specific application program can be easily started up.

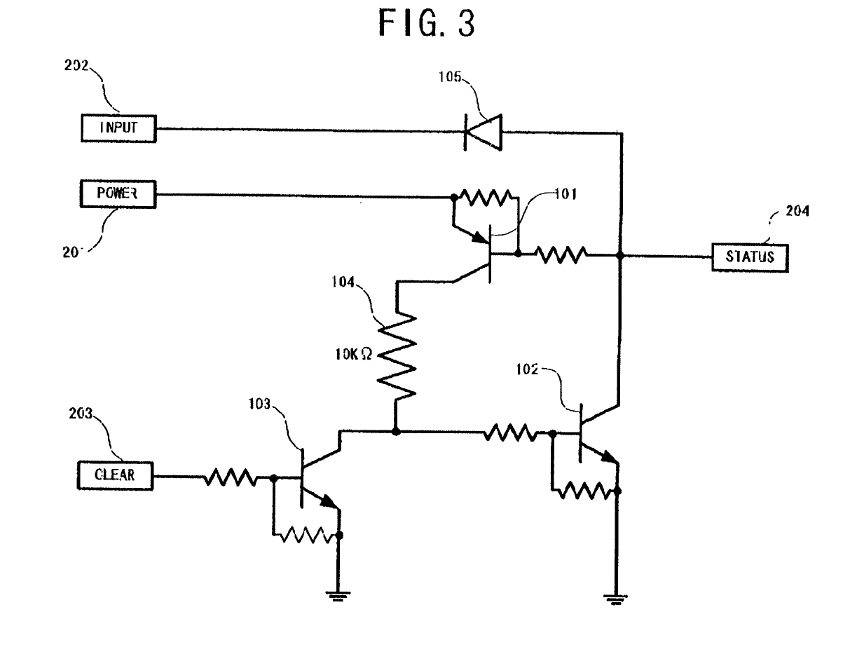

A detailed explanation will be next given of status memory 33 with reference to FIG. 3 and FIGS. 4A to 4G.

As illustrated in FIG. 3, the status memory 33 is one-bit memory composed of three digital transistors (transistors structured such that switching operation is performed) 101 to 103, resistor 104 (if about 10KΩ, and diode 105.

Additionally, the bias resistance value of digital transistors 101 to 103 is sufficiently large as compared with the resistance value 10KΩ of resistor 104. Moreover, in the initial state where the system power source is OFF, all transistors 101 to 103 are turned off.

The following will explain the operation of status memory 33 with reference to the timing chart illustrated in FIGS. 4A to 4G.

In the power OFF state, as illustrated in FIGS. 4A to 4G, the INPUT terminal 202 and STATUS terminal 204 are in a high impedance (Hi Z) state, the signal with “0” value (ground level) is applied to the CLEAR terminal 203 and all transistors 101 to 103 are in the OFF state.

Here, when shortcut button 22 is depressed, “0” is input to an INPUT terminal 202, the system power source is turned on a little later, and a signal with a high level (“1”) is supplied to a POWER terminal 201 as illustrated in FIGS. 4A and 4B. For this reason, as illustrated in FIG. 4H., the digital transistor 101 is turned on.

When the digital transistor 101 is turned on, the base potential of digital transistor 102 rises and the digital transistor 102 is turned on as illustrated in FIG. 4F. As a result, “0” appears at a STATUS terminal 204.

As mentioned above, after turning on the main power, the CPU 28 performs initialization processing to start up the operating system, gains access to the I/O controller 34 and reads the level of the signal supplied to the input terminal GPI. When determining that the input is “0”, the CPU 28 rewrites the output of output terminal GPO to “1.” When “1” is input to the CLEAR terminal 203 by this operation, the digital transistor 103 is turned on as illustrated in FIG. 4G. For this reason, as illustrated in FIGS. 4F and 4E, the base voltage of transistor 102 decreases, the transistor 102 is turned off, and the transistor 101 is further turned off. Accordingly, as illustrated in FIG. 4C, “1” appears at a STATUS terminal 204.

While, in the case where the system power source is turned on by the depression of power button 23, the INPUT terminal 202 is in a high impedance state at the time when the system power source is turned on. For this reason, the transistor 101 stays in the OFF state. Accordingly, the STATUS terminal 204 also stays in the high impedance state.

Additionally, in the present embodiment, it is assumed that the aforementioned “1” and “0” are not analog quantities but digital quantities. Moreover, regarding each of the digital transistors 101 to 103 illustrated in FIG. 3, it is assumed that the source and drain are electrically connected to each other by inputting “1” to the base terminal. Still moreover, it is assumed that the level of power voltage applied when the system power source is turned on is also determined as “1” viewing from the digital quantity.

Additionally, the circuit configuration relating to FIGS. 1 and 3 may be arbitrarily changed. For example, lines, L1 and L2 may be pulled up by the backup power BK. Furthermore, the operation of CPU shown in FIG. 2 may be suitably changed.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope at the present invention.

This application is based on Japanese Patent Application No. 2000-307797, filed on Oct. 6, 2000 and including specification, claims, drawings and summary. The disclosure of the above Japanese Patent Application is incorporated herein by reference in its entirety.

What is claimed is:

1. A computer system comprising:
a predetermined switch for instructing a system power source to be turned on and an application program to he executed;
a power switch for instructing said system power source to be turned on;
status memory for detecting the depression of said predetermined switch to store a status signal indicative of the detection result;
a mask circuit for outputting an ON signal in a state that said system power source is turned off and no ON signal in a state that said system power source is turned on in response to the depression of said predetermined switch:
a power control circuit for turning on said system power source in response to an operation of said power switch and said ON signal:
a processor, which operates by using said system power source, for accessing said status signal stored in said status memory in response to the start of the supply of power from said system power source so as to start up a predetermined application program when said status signal indicates said predetermined switch has been operated: and
a controller, which operates by using the system power source, for detecting the depression of said predetermined switch to output a signal for instructing said processor to start up said predetermined application program, whereby making it possible to turn on said system power source and start up said predetermined application program in response to the operation of said predetermined switch.

2. The computer system according to claim 1, wherein said predetermined switch outputs a signal with a predetermined level by the operation, and said status memory stores the status signal indicating the level of the signal output by said predetermined switch at the time when power supply from said system power source is started.

3. The computer system according to claim 1, wherein said controller comprising:
a switch circuit, which operates by using the system power source, for detecting the depression of said predetermined switch to output a predetermined switch operation signal; and
a keyboard controller for detecting said switch operation signal to output an interrupt signal for instructing said processor to start up said predetermined application program.

4. The computer system according to claim 1, wherein said processor clears the content stored in said status memory after starting up said predetermined application program.

5. A computer system comprising:
a predetermined key for instructing a system power source to be turned on and an application program to be executed;
a power control circuit for turning on the system power source when said predetermined key is depressed in a state that said system power source is in an OFF state; and
a processor, which operates by using the system power source, for executing an application program corresponding to said specific key when said specific key is depressed.

6. The computer system according to claim 5, further comprising status memory for storing the depression of said predetermined key, wherein said processor accesses to the content stored in said status memory, determines whether or not said system power source is turned on by the depression of said predetermined key, and executes said application program corresponding to said predetermined key when it is determined that said system power source is turned on by the depression of said predetermined key.

7. A keyboard controller control system according to claim 5, wherein said processor starts up said application corresponding to said predetermined key and clears the content stored in said status memory when said system power source is turned on by the depression of said predetermined key.

8. The computer system according to claim 5 wherein said processor starts up said predetermined application when said predetermined key is depressed for a time period over which said system power source is turned on.

9. The computer system according to claim 5, further comprising a power circuit; and wherein said power control circuit detects the depression state of said predetermined key to turn on said system power source by supplying a trigger signal to said power circuit when detecting the depression of the corresponding specific key.
